(19) United States
(12) Patent Application Publication
(10) Pub. No.: US 2009/0024844 A1
(43) Pub. Date: Jan. 22, 2009

(54) Terminal And Method For Receiving Data In A Network

(75) Inventor: Prashanth Pigileti Sriram, Bangalore Karnataka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 12/174,405

(22) Filed: Jul. 16, 2008

(30) Foreign Application Priority Data
Jul. 16, 2007 (IN) 1522/CHE/2007

(51) Int. Cl. H04L 9/08; G06F 15/16

(52) U.S. Cl. 713/155; 709/217

(57) ABSTRACT

Terminal and Method for Receiving Data in a Network In embodiments of the present invention, a method of processing data in a network is provided. In the method, a terminal receives data from the network and is operated in two states. In the first state, in which the terminal is connected to the network, the terminal causes the data to be usable. In the second state, in which the terminal is not connected to the network, the terminal causes the data to be unusable.

### RELATED APPLICATIONS

This patent application claims priority to Indian patent application serial number 1522/CHE/2007, having title “Terminal and Method for Receiving Data in a Network”, filed on 16 Jul. 2007 in India (IN), commonly assigned herewith, and hereby incorporated by reference.

### BACKGROUND OF THE INVENTION

In recent years, networks in which data is transmitted and shared between multiple terminals have become commonplace. In such networks, the data may be transmitted via local or wide area networks, via cables or wirelessly, and/or using telephone lines or the like. The terminals referred to are computing devices or the like and include user terminals such as desktop or laptop computers and handheld devices such as mobile phones and PDAs, as well as other devices such as servers.

Such networks provide a convenient and efficient way of allowing each user to access data from and provide data to other users of the network. Typically, information provided to the network from one terminal can be accessed, and perhaps modified, by other users.

The data that can be accessed in some networks can be of a confidential nature. This may be the case where the network is an intranet or other network of an organisation such as a company, where the information may include internal data, trade secrets etc. Such data may be of considerable value to the organisation concerned, and it may, therefore be extremely important to such organisations that such information is not intentionally or unintentionally communicated outside of the organization, or to unauthorised persons.

Accordingly, access to networks in such organisations is typically permitted only for authorised persons. These persons may identify themselves to the network using, for example, a username and/or password, which is verified by the network, and access to data in the network may only be allowed after such verification. Some networks employ cryptographic techniques for transmitting data securely in the network in order to prevent, inter alia, malicious third parties from “listening-in” and gaining access to data as it is being transmitted.

However, once an authorized person has legitimately gained access to the network, he or she may proceed to download data onto their terminal and store it in a memory of the terminal. This data may then be removed from the organisation, by, for example, transferring the data to a portable storage device, such as a CD, or transmitting the data in a non-secure manner within another network to which the terminal may have access (such as the Internet). Therefore, there exists a danger of sensitive data accessed legitimately being transferred outside of the organisation and accessed by third parties.

It is an object of the present invention to mitigate at least some of the problems of existing systems.

### SUMMARY OF THE INVENTION

According to a first aspect, the present invention provides a method of processing data in a network, said method comprising:

receiving data at a terminal from said network;

operating said terminal in a first state when said terminal is connected for communicating with said network, wherein said terminal renders said data usable; and

operating said terminal in a second state when said terminal is not connected for communicating with said network, wherein said terminal renders said data unusable.

According to another aspect, the present invention provides a terminal for receiving data in a network, said terminal comprising;

means for receiving cryptographic information from said network;

first storage means for storing said cryptographic information;

means for receiving encrypted data from said network;

second storage means for storing said encrypted data;

processing means for decrypting said encrypted data using said cryptographic information; and

third storage means for storing the decrypted data, wherein said terminal is arranged such that said cryptographic information is not usable at said terminal when said terminal is not connected to said network.

According to yet another aspect, the present invention provides method of accessing data in a network of computing entities, wherein data is transmitted between computing entities of the network in an encrypted state, said method comprising:

establishing a communications connection between a terminal and said network;

identifying the terminal to the network and, in response, receiving and storing cryptographic information in a first store of said terminal;

receiving encrypted data from said network and storing said encrypted data in a second store of said terminal;

decrypting said encrypted data using said cryptographic information and storing the decrypted data in a third store of said terminal; and

in response to any disconnection of the terminal from said network, rendering said decrypted information unusable at said terminal while said terminal is disconnected from said network

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a block diagram showing a plurality of terminals, an authenticating device, a network and connections between them, in accordance with an embodiment of the present invention;

FIG. 2 is a schematic diagram of components of a terminal in accordance with an embodiment of the present invention;

FIG. 3 is a flow diagram showing the operation of a terminal connecting to and disconnecting from a network, and receiving and using cryptographic information, in accordance with an embodiment of the present invention;

FIG. 4 is a flow diagram showing data being retrieved and displayed on a terminal in accordance with an embodiment of the present invention.;

FIG. 5 is a flow diagram showing data being stored on a terminal in accordance with an embodiment of the present invention; and

FIG. 6 is a schematic diagram showing the interaction between components of an application layer, an operating system layer and a hardware/data transfer layer of the terminal.

### DETAILED DESCRIPTION OF THE INVENTION

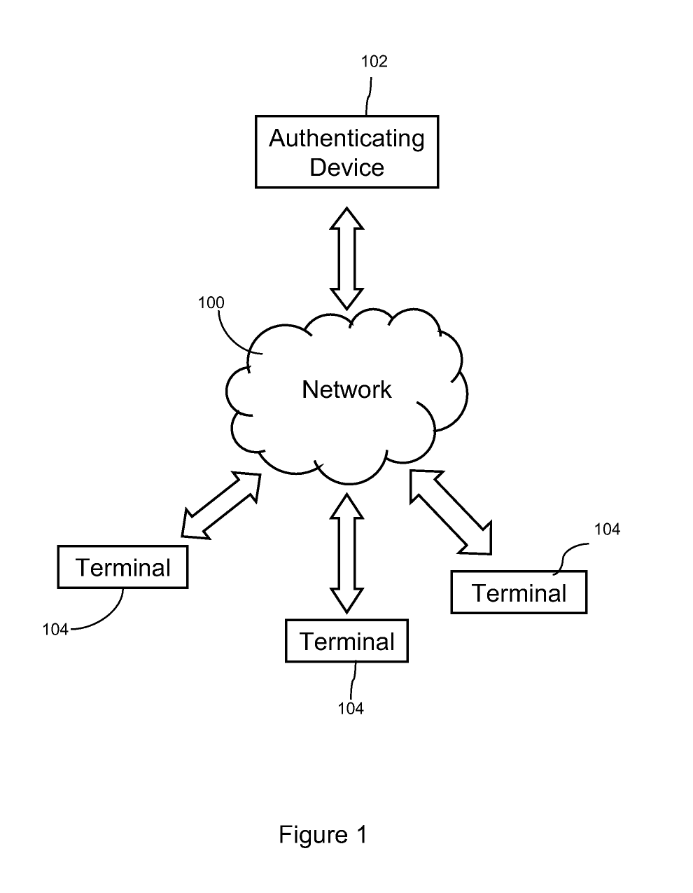

A system in which certain embodiments of the present invention are implemented is shown in FIG. 1. Terminals 104 according to embodiments of the present invention communicate with one another and with an authenticating device 102 (described below) via a network 100. The authenticating device may comprise an authenticating server. Typically, a large number of terminals are connected to the network, but here, for conciseness, only three are shown. In the following discussion, the term “connection” refers to a communications connection which enables data to be transmitted between devices; establishing such a connection typically involves a user log-in. Although FIG. 1 shows the terminals 104 and the authenticating device 102 separately from the network 100, for many purposes the terminals 104 and the authenticating device 102 may be considered to be part of the network 100. The network may comprise, for example, an intranet of a company or other organisation. In some embodiments access to the network is possible only within a specific physical location, such as within a company building; in other embodiments, the network is additionally accessible from a variety of locations, such as the home of an employee, or via any internet connection.

Data is communicated between the components of the network in encrypted form. In some embodiments all data transmitted is encrypted; in other embodiments, only sensitive data is encrypted. The data typically represents information, such as word-processing documents; it may additionally or alternatively represent control information such as remote commands, results of such commands, database transactions, and so on.

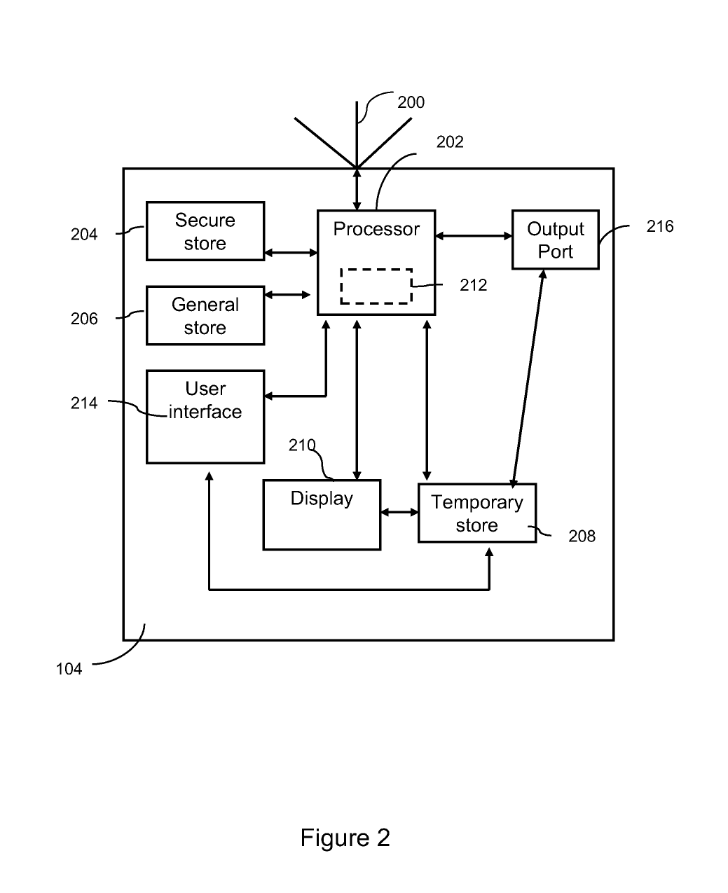

FIG. 2 shows components of a terminal 104 in accordance with embodiments of the present invention. A “terminal” here means any computing device capable of transmitting and/or receiving data in the network 100; examples of such terminals include laptop computers, desktop computers, mobile telephones, PDAs etc.

The terminal 104 comprises a transceiver 200 by which data is transmitted to and received from other components of the network 100. Typically, where data is transmitted wirelessly, the transceiver 200 comprises an antenna; additionally, or alternatively, it may comprise a port for connecting to a telephone line or other wire network. In many arrangements, a transceiver controller (not shown here) is used between the transceiver and the processor.

The terminal also comprises a processor 202 for performing processing of data, which includes a security module 212 for encrypting and decrypting data, as will be described below. The security module may be implemented as a file system module, or as part of a device driver or any other functional layer of the operating system contributing to data transfers. Alternatively, or additionally, the security module 212 could be implemented as an application or as a component of the firmware or hardware. The terminal 104 also includes a secure store 204, a general store 206, a temporary store 208, a display 210 a user interface 214 and an output port 216, all of whose functions will be described below. Each of these may comprise a single component or a collection of components; for example each of the stores 204, 206, 208 may comprise a plurality of stores.

The secure store 204 is arranged to be secure such that it is at least very difficult to access its contents externally by hacking etc. In some embodiments, the secure store 204 may be part of an operating system of the terminal 104; it may be implemented as a part of file system, device driver or any other functional layer of the operating system contributing to data transfers. Alternatively, or additionally, the secure store 204 could be implemented in an application or firmware or hardware. Although the secure store 204 and the security module 212 are shown separately here, in many cases the secure store 204 is part of the security module 212. In some embodiments, each of the components of the terminal 104 described here are physical devices; in other embodiments, at least some of the components may be software components. In many cases, the general store 206 and the temporary store 208 are controlled by the security module 212.

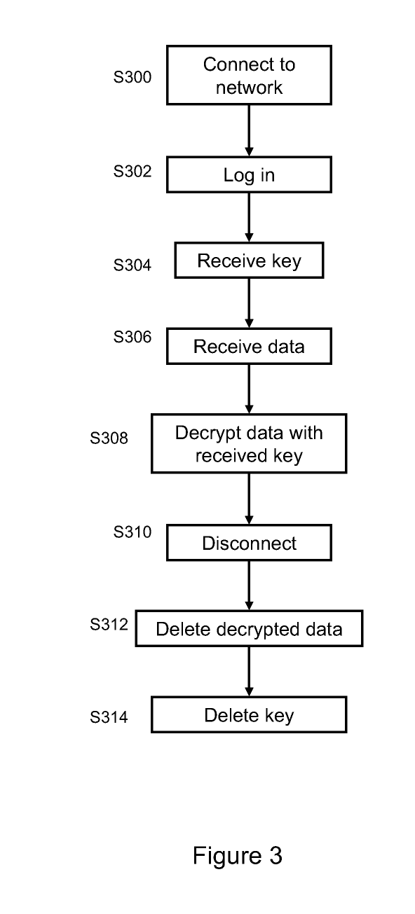

After connecting with the network 100, each terminal 104 identifies itself to the authenticating device and after authenticating successfully, gains access to cryptographic information, such as a key from the authenticating device 102, as is now described with reference to FIG. 3. At step S300 the terminal connects to the network. At step S302, the terminal 104 logs-in to the network 100, which may involve a user providing a username and/or password to the authenticating device 102. It is preferable that the connection between the terminal 104 and the authenticating device 102 be a secure connection. In some preferred embodiments, the terminal 104 may provide a certificate in order to verify the log-in details provided. The certificate may comprise a digital signature and/or have been certified by a certificate authority. In some preferred embodiments, the authenticating device 102 also provides a certificate of its credentials to the terminal 104. These measures prevent third parties from gaining access to, for example, the log-in credentials transmitted by the terminal 104 using, for example, a man-in-the-middle attack.

Since a central authenticating device 102 is used, it is unnecessary for each terminal 104 and other devices of the network 100 to verify the credentials of the device with which they are sharing information. Where desired, multiple authenticating servers could be provisioned for load sharing or redundancy.

When the authenticating device 102 has verified the credentials of the terminal 104, which may be user credentials, it provides the terminal 104 with cryptographic information, allowing the terminal 104 to decrypt data received from the network 100; the cryptographic information is received by the terminal 104 at step S304. Typically, the cryptographic information comprises a key, and in the following discussion, the cryptographic information will be referred to as a “key”, but other types of cryptographic information, such as cryptographic algorithms, encryption timestamps, index to a well known set of keys and so on are also possible. In some cases the cryptographic information may comprise a key pair (e.g. a public/private key pair), with one key being used to decrypt received data, and the other for encrypting data for sending to the network, for example. In some arrangements, more than one set of cryptographic information may be provided to the terminal 104, and different types used depending on the level of security of the data concerned.

In certain embodiments of the present invention, the key is communicated to the terminal using a secure method such as HTTPS, SSH or similar methods implementing secure protocols such as SSL.

Having received the key, the terminal 104 stores it in the secure store 204, such that it cannot be easily externally accessed and/or retrieved by third parties attempting to gain access to the network. At step S306, the terminal 104 receives encrypted data from the network. This encrypted data may originate from another terminal 104, or from some other device. The encrypted data is stored without being decrypted in the general store 206 of the terminal 104. In order to use the data, it must be decrypted at step S308. This is done by the security module 204 using the key stored in the secure store 204. Once the data has been decrypted it may be used by a user or a software application, for example, to display information to a user, or to run a process, depending on the form of the information decrypted, as will be described below.

Thus, when the terminal 104 is connected to the network, it can decrypt encrypted data received from the network 100 using the decryption data stored in the secure store 204 and the security module 212, and use the thus decrypted data for a suitable purpose. Step S306 and step S308 may be repeated any number of times while the terminal 104 is connected to the network 100. However, at step S310, the terminal 104 is disconnected from the network 100. In some cases, this disconnection involves a physical disconnection from a port; in other cases it may involve only a user log-out without any physical disconnection. In response to this disconnection, any decrypted data stored anywhere in the terminal 104, for example in the temporary store 208 (which will be described below) is deleted at step 312. In some cases, the processor 202 includes devices for storing data temporarily; and data stored in these is also deleted. Typically, the deleting is done in response to a command from the processor 202. At step S314, the key stored in the secure store 204 is deleted. Thus, upon disconnection from the network, there is no longer any decrypted data anywhere in the terminal 104, and furthermore, although encrypted data may still be stored in the general store 206, since the key has been deleted from the secure store 204, it is no longer possible to decrypt this data into a useful form. Thus, when not connected to the network 100, data obtained from the network 100 or local storage cannot be used, saved or transmitted in an unsecure (that is, unencrypted) form.

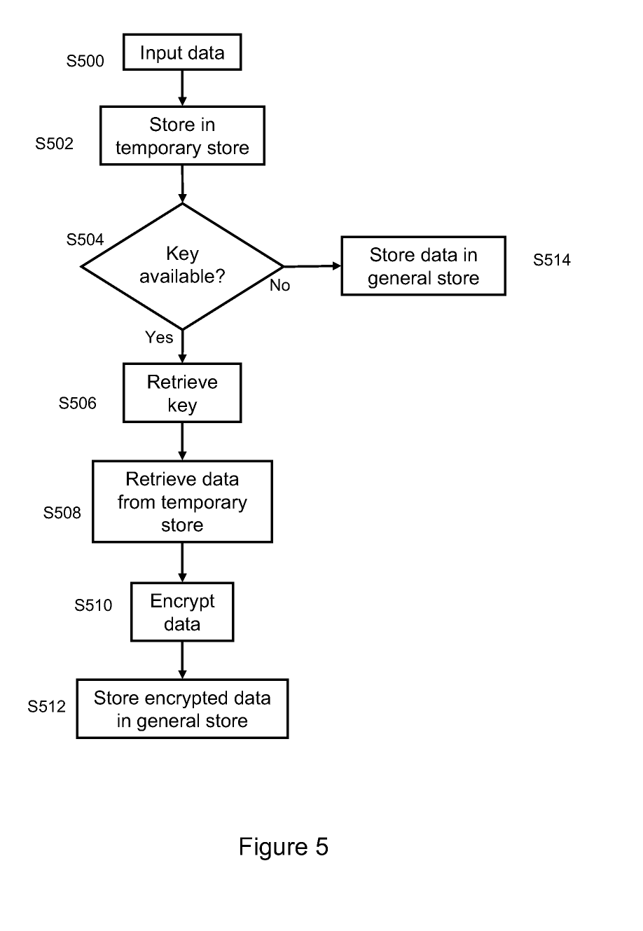

In the example process described above with reference to FIG. 3, the decrypted data stored in the general store 206 was not deleted in response to the disconnection. This provides an advantage that any data stored in the general store 206, which, as will be described below with reference to FIG. 5, may include data added or modified by the user, can be accessed the next time the terminal 104 is connected to the network, without having to re-retrieve the data from the network. Furthermore, it also means that data can be stored locally on the terminal in the general store 206 without having to transmit all data to elsewhere in the network for storing. However, in some examples it may provide additional security to delete the data stored in the general store 206 in response to the disconnection.

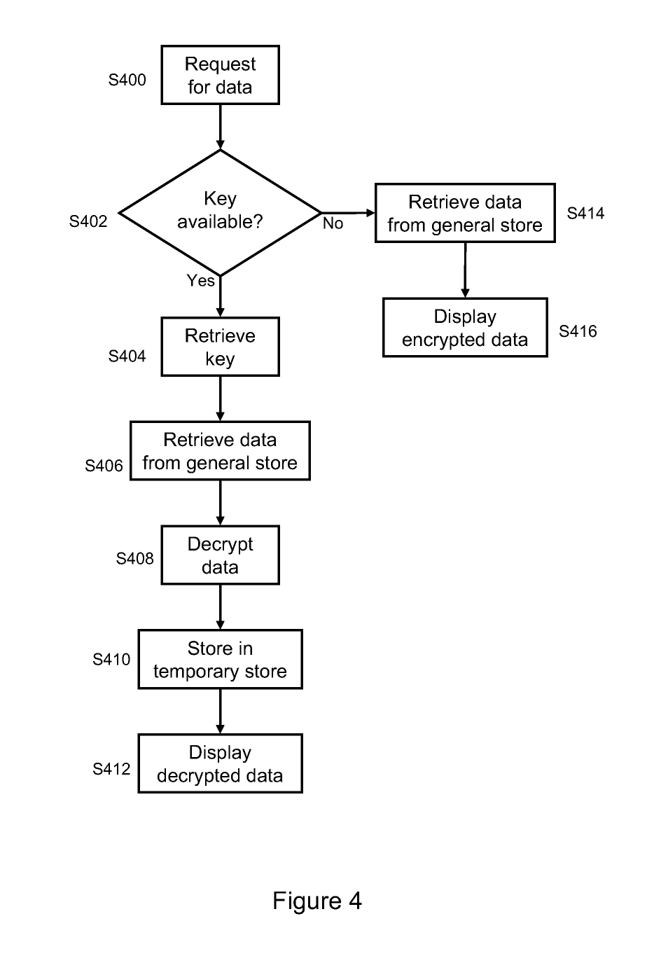

An example of retrieving and displaying data stored in the general store 206 is now described with reference to FIG. 4. At step S400, a request for data is made. This may comprise the user of the terminal 104 attempting to access a file or document stored in the general store 206 by making an input into the user interface 214. At step S402 it is determined whether the key is available by, for example, checking to see whether it is stored in the secure store 204. If the key is available, it is sent from the secure store 204 to the processor 202 at step S404. Then at step S406, the requested data is retrieved from the general store 206 and sent to the processor 202, where it is decrypted using the security module 212. At step S410 the decrypted data is stored in the temporary store 208, from which it is sent to the display 210 and displayed to the user at step S412.

Returning to step S402, if the key is not available, the requested data is retrieved from the general store 206 at step S414, and displayed in encrypted form at step S416. Since the data is displayed in encrypted form, it cannot be used or understood by the user; this prevents the data from escaping from the network in a useful form.

It should be noted that the determination as to the availability of the key at step S402 is equivalent to a determination as to whether the terminal 104 is connected to the network 100, since, as discussed above, the key is available if and only if the terminal 104 is connected 100. Thus, any attempt to access and display data when not connected to the network 100 results in unintelligible encrypted data being displayed (or the display operation failing). In other examples, alternative or additional methods of determining whether the terminal 104 is connected may be used, such as directly determining whether the user is logged-in.

A similar process to that described with reference to FIG. 4 should be used for functions other than display; for example, for sending data to the output port 216, which may provide access to a printer, for example, for printing a document, or to a storage device, such as a flash key, CD, hard disk etc. Particularly where the network 100 can only be accessed in specified physical environments, this allows the output of decrypted data to be limited to such environments where it can be controlled.

An example process of data being input and stored in the terminal 104 is now described with reference to FIG. 5. Data is input at step S500; this may comprise, inter alia, a user entering data using the user interface 214, or data being input from a portable storage device such as a compact disk. This data is stored in the temporary store 208 at step S502; this may be in response to a user action, such as choosing a save option of a word-processing program. At step S504, it is determined whether the key is available, for example by checking whether it is stored in the secure store 204. If the key is available, as is the case when the terminal 104 is connected to the network 100, it is retrieved at step S506. The data stored in the temporary store is retrieved at step S508, and encrypted at step S510, using the security module 212. The encrypted data is then stored in the general store at step S512.

The data input at step S500 may include data previously retrieved from the network and decrypted, as described above; it may comprise modifications or additions to such decrypted data made by the user. Thus, when the terminal 104 is connected to the network 100, any modifications or additions made to data retrieved from the network are stored in the general store 206 in encrypted form. Any data not saved in the general store 206 is deleted from the terminal 104 on disconnection from the network 100, as described above; thus, data input and saved by the user during a connection is saved in encrypted form, ensuring that modified/additional data is not available in decrypted form outside the network 100.

Returning to step S504, if the key is not available, this implies that the terminal 104 is not connected to the network 100, and that sensitive data is not therefore being used. As such, any input by the user (or any other form of input) is assumed neither to be sensitive, nor to be a modification of or addition to sensitive data and therefore safe to store in the general store 206 in unencrypted form. The data is therefore stored in the general store 206 at step S514.

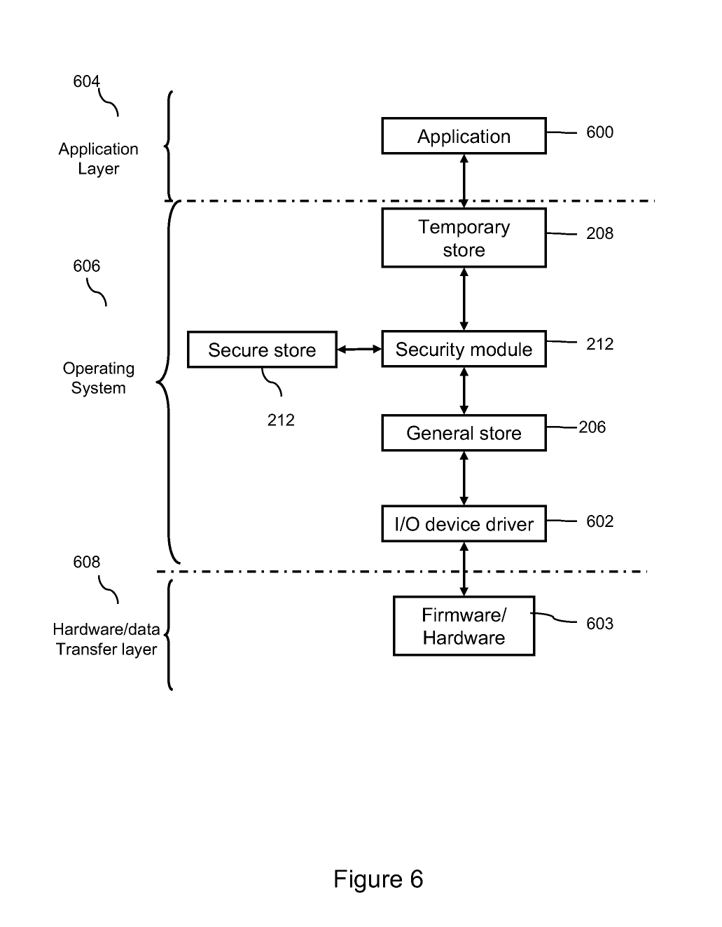

An example of the action of the terminal 104 in decrypting data received from the transceiver 200 is now described with reference to FIG. 6, which shows an application layer 604, an operating system 606 and a hardware/data transfer layer 608. The application layer comprises an application 600 such as a word processing program. The operating system 606 comprises the temporary store, security module 212, general store 206 and secure store 212 described above as well as an Input/Output (I/O) device driver 602 which interacts with firmware and/or hardware 603, which is included in the hardware/data transfer layer 608. The firmware/hardware 603 may comprise the transceiver 200 or the output port 216 described above. Encrypted data is received from the firmware/hardware 603 and transferred to the general store 206 via the transceiver controller 602. The data is stored in the general store 206 in encrypted form, until it is decrypted by the security module 212. The security module 212 may decrypt this automatically in response to the data entering the general store 206 or it may only decrypt the data when prompted to do so by, for example, a user action. The security module 212 accesses the key in the secure store 212 and decrypts data stored in the general store 206. Decrypted data is then stored in the temporary store 208, from which it may be accessed and used by the application 600; the application may display the decrypted data to a user.

An example of data flow from the application to the transceiver is now described. Data is inputted, for example by user input, using the application 600 and stored in the temporary store 208. If the data is to be output to the firmware/hardware 603, it must first be encrypted; this is done by the security module using a key from the secure store (note that this is typically a different key to the key used for decrypting data). Once encrypted, the data is stored in the general store 206 and subsequently transferred to the firmware/hardware 603 via the I/O transceiver controller 602.

Thus, in embodiments of the invention, an operating system of the terminal 104 is adapted to receive encrypted data (from the general store 206 or network 100) and to decrypt the data for all display operations. For all other output operations the operating system is adapted to re-encrypt the data. These other operations may include software operations such as “cut n paste”, so that data is re-encrypted for performing paste operations. The data may be stored in decrypted form in the temporary store 208 after cutting, and encrypted using a key prior to pasting. Any cut data stored in the temporary store 208 is deleted when the terminal 104 is disconnected. In some arrangements this is achieved by adding an overlay process that resides above the operating system, such that all input and output is directed by the operating system through the overlay process.

The above embodiments are to be understood as illustrative examples of the invention. Further embodiments of the invention are envisaged. For example, the order of some of the steps described in relation to the Figures may be altered without departing from the scope of the present invention. For example, in the above discussion in relation to FIG. 3, the decrypted data was deleted prior to the key being deleted; in some arrangements, this order may be reversed, or both steps performed simultaneously.

In the process of FIG. 5, data is stored in the temporary store 208 prior to being stored in the temporary store 206 after inputting. In some arrangements, the step of storing in the temporary store may be omitted.

In the process of FIG. 4, when the key is not available, data is displayed in encrypted form. In some arrangements, the data is not displayed at all.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, devices or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of processing data in a network, said method comprising:
receiving data at a terminal from said network;
operating said terminal in a first state when said terminal is connected for communicating with said network, wherein said terminal renders said data usable; and
operating said terminal in a second state when said terminal is not connected for communicating with said network, wherein said terminal renders said data unusable.

2. A method according to claim 1, wherein said data comprises encrypted data.

3. A method according to claim 2, comprising receiving cryptographic information at said terminal from said network.

4. A method according to claim 3, comprising using said cryptographic information to decrypt said encrypted data when operating said terminal in said first state.

5. A method according to claim 4, comprising deleting said decrypted data in response to a transition from said first state to said second state.

6. A method according to claim 3, comprising deleting said cryptographic information in response to a transition from said first state to said second state.

7. A method according to claim 1, wherein said first state comprises a state wherein a communications connection has been established between the terminal and the network, wherein establishing the communications connection comprises providing an identifier of said terminal to the network.

8. A method according to claim 1, wherein said first state comprises a state wherein a user is logged-in to said network.

9. A method according to claim 1, wherein said second state comprises a state wherein a user is logged-out from said network.

10. A method according to claim 3, wherein said cryptographic information comprises a cipher and/or a key.

11. A method according to claim 4, wherein different cryptographic information is used depending on the security level of the data.

12. A method according to claim 4, wherein said data is decrypted in response to a request for said data.

13. A method according to claim 12, wherein, in response to a further request for said data when operating said terminal in said second state, said data is not decrypted.

14. A method according to claim 13, wherein, in response to said further request, said data is presented in an unusable form.

15. A method according to claim 4, wherein the decrypted data is encrypted and stored in an encrypted state.

16. A terminal for receiving data in a network, said terminal comprising;
a receiver for receiving cryptographic information from said network;
a first store for storing received cryptographic information;
a receiver for receiving encrypted data from said network;
a second store for storing received encrypted data;
a processor for decrypting said encrypted data using said cryptographic information; and
a third store for storing the decrypted data,
wherein said terminal is arranged such that said cryptographic information is not usable at said terminal when said terminal is not connected to said network.

17. A terminal according to claim 16, wherein said first store comprises a secure store which is not externally accessible.

18. A terminal according to claim 16, wherein said secure store is contained in an operating system of said terminal.

19. A terminal according to claim 16, wherein network comprises a server, and said cryptographic information is received from said server.

20. A method of accessing data in a network of computing entities, wherein data is transmitted between computing entities of the network in an encrypted state, said method comprising:
establishing a communications connection between a terminal and said network;
identifying the terminal to the network and, in response, receiving and storing cryptographic information in a first store of said terminal;
receiving encrypted data from said network and storing said encrypted data in a second store of said terminal;
decrypting said encrypted data using said cryptographic information and storing the decrypted data in a third store of said terminal; and
in response to any disconnection of the terminal from said network, rendering said decrypted information unusable at said terminal while said terminal is disconnected from said network.
